(19) United States
(12) Patent Application Publication
(10) Pub. No.: US 2026/0112360 A1
(43) Pub. Date: Apr. 23, 2026

(54) RECORDING MEDIUM, INFORMATION PROCESSING APPARATUS, AND INFORMATION PROCESSING METHOD

(71) Applicant: Konica Minolta, Inc., Tokyo (JP)

(72) Inventor: Natsuko MINEGISHI, Tokyo (JP)

(21) Appl. No.: 19/356,671

(22) Filed: Oct. 13, 2025

(30) Foreign Application Priority Data
Oct. 18, 2024 (JP) 2024-182348

(51) Int. Cl. G10L 15/18; G06T 11/20; G10L 15/08; G10L 15/183

(52) U.S. Cl. CPC G10L 15/1815; G06T 11/26; G10L 15/183; G10L 2015/088

(57) ABSTRACT

A non-transitory computer-readable recording medium stores a computer-executable information processing program. The program causes a computer to function as: an extractor that extracts, from a conversation for determining a requirement of a design, a first word related to the requirement of the design; a first calculator that calculates a first similarity that is a similarity between a meaning of the first word extracted by the extractor and a meaning of a second word that expresses an impression evoked or a physiological phenomenon induced in an observer by a design element; a determiner that determines suggested information on the design element for realizing the impression or the physiological phenomenon expressed by the second word for which the first similarity calculated by the first calculator is equal to or greater than a predetermined value; and a display controller that displays the suggested information determined by the determiner on a display.

### CROSS-REFERENCE TO RELATED APPLICATIONS

The entire disclosure of Japanese Patent Application No. 2024-182348 filed on Oct. 18, 2024, is incorporated herein by reference in its entirety.

### BACKGROUND OF THE INVENTION

### Technical Field

The present disclosure relates to a recording medium, an information processing apparatus, and an information processing method.

### Description of Related Art

In general, design images of various designs are used for product packaging, advertisements, and the like. In the past, methods for supporting production of a design image have been disclosed.

For example, the following design production support method is described in JP 2014-59911A. Specifically, a design rule or a model based on the principles of human cognitive science and visual science is used to support the production of a design in content.

### SUMMARY OF THE INVENTION

In the production of a design image, when sharing a request of a client between the client and a producer, it may be difficult to share an image in the design image. Therefore, there is a problem in that the design image produced by the producer is required to be corrected by the client even if there is no satisfactory basis for the corrections, resulting in an increase in the production time of the design image.

An object of the present disclosure is to provide a non-transitory computer-readable recording medium storing an information processing program, an information processing apparatus, and an information processing method that support efficient production of a design image.

To achieve at least one of the abovementioned objects, a recording medium reflecting one aspect of the present invention is a non-transitory computer-readable recording medium storing a computer-executable information processing program, the program causing a computer to function as: an extractor that extracts, from a conversation for determining a requirement of a design, a first word related to the requirement of the design; a first calculator that calculates a first similarity that is a similarity between a meaning of the first word extracted by the extractor and a meaning of a second word that expresses an impression evoked or a physiological phenomenon induced in an observer by a design element; a determiner that determines suggested information on the design element for realizing the impression or the physiological phenomenon expressed by the second word for which the first similarity calculated by the first calculator is equal to or greater than a predetermined value; and a display controller that displays the suggested information determined by the determiner on a display.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a block diagram illustrating a functional configuration of an information processing apparatus according to a first embodiment of the present disclosure;

FIG. 2 is a diagram illustrating an example of a correlation model indicating a correspondence relationship between a degree of a design element and a degree of an impression;

FIG. 3 is a diagram illustrating an example of a sample image for evaluating an impression on a design element;

FIG. 4 is a flowchart illustrating a direction suggestion process executed by the information processing apparatus;

FIG. 5 is an example of a display screen;

FIG. 6 is a diagram illustrating an example of a suggested design direction;

FIG. 7 is a diagram illustrating an example of an image as reference information;

FIG. 8 is a diagram illustrating an example of an image as the reference information;

FIG. 9 is a diagram illustrating an example of a two-dimensional map on which request keywords are plotted;

FIG. 10 is a diagram illustrating an example of a two-dimensional map on which a range of request keywords is displayed;

FIG. 11 is a flowchart illustrating a matching degree determination process executed by the information processing apparatus;

FIG. 12 is a diagram illustrating an example of a two-dimensional map on which degrees of respective design elements constituting an input image and their center of gravity are plotted;

FIG. 13 is a diagram illustrating an example of a two-dimensional map on which the center of gravity of the degrees of the respective design elements constituting the input image is displayed;

FIG. 14 is a diagram illustrating an example of a display screen on which a matching degree is displayed;

FIG. 15 is a flowchart illustrating an originality display process executed by the information processing apparatus;

FIG. 16 is a diagram illustrating an example of a two-dimensional map on which the center of gravity and a range of typical designs are plotted;

FIG. 17 is a diagram illustrating an example of a display screen on which requested “originality” is displayed;

FIG. 18 is a diagram illustrating an example of a two-dimensional map on which the degrees of the respective design elements constituting the input image and the center of gravity and the range of typical designs are plotted;

FIG. 19 is a diagram illustrating an example of a display screen on which the requested “originality” and the “originality” in the input image are displayed;

FIG. 20 is a diagram illustrating an example of a report output in a matching degree determination process according to a second embodiment; and

FIG. 21 is a flowchart illustrating a conventional direction suggestion process.

### DETAILED DESCRIPTION

Hereinafter, one or more embodiments of the present invention will be described with reference to the drawings. However, the scope of the invention is not limited to the disclosed embodiments.

### First Embodiment

A first embodiment of the present disclosure will be described.

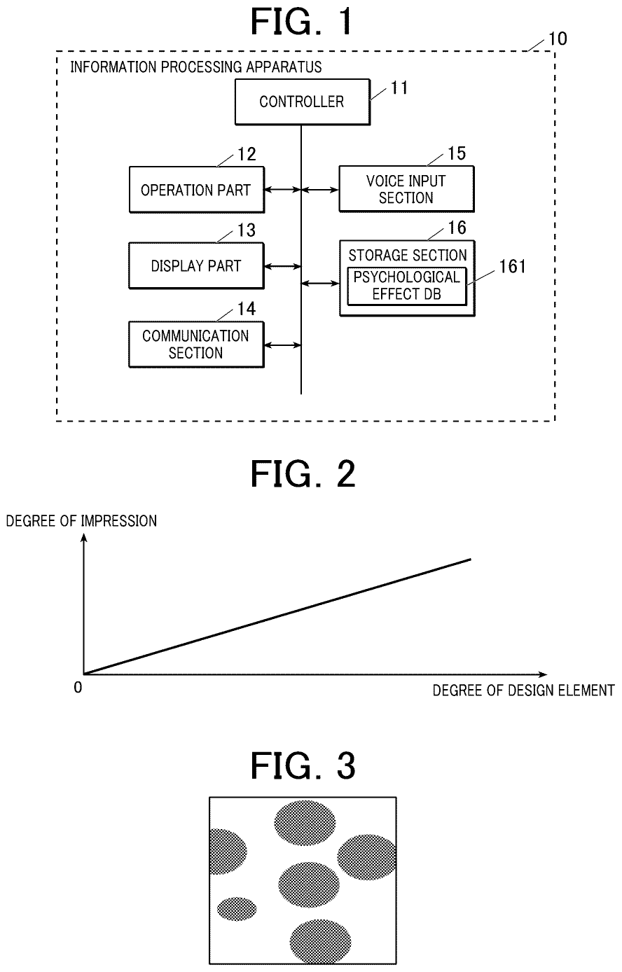

FIG. 1 illustrates a functional configuration of an information processing apparatus 10 according to the first embodiment. As illustrated in FIG. 1, the information processing apparatus 10 includes a controller (hardware processor) 11, an operation part 12, a display part (display) 13, a communication section 14, a voice input section 15, a storage section 16, and the like, and these components are connected to each other by a bus. The information processing apparatus 10 is a computer apparatus such as a personal computer (PC).

The controller 11 includes a central processing unit (CPU), a random-access memory (RAM), and the like.

The CPU comprehensively controls the processing operation of each component of the information processing apparatus 10. Specifically, the CPU reads various processing programs stored in the storage section 16, develops the programs in the RAM, and performs various kinds of processing in cooperation with the programs.

The operation part 12 includes a keyboard having cursor keys, character input keys, number input keys, various function keys, and the like, and a pointing device such as a mouse. The operation part 12 outputs, to the controller 11, a signal input by a key operation on the keyboard and/or a mouse operation. The operation part 12 may include a touch screen laminated on the display part 13, receive a user input for a display screen, and output an operation signal corresponding to the position of a touch operation to the controller 11.

The display part 13 includes a monitor such as a liquid crystal display (LCD) and displays various screens according to instructions of display signals input from the controller 11.

The communication section 14 includes a network interface and the like. The communication section 14 transmits and receives data to and from an external device connected via a communication network such as a local area network (LAN), a wide area network (WAN), or the Internet.

The voice input section 15 includes a microphone and the like, acquires a voice signal such as a user voice, converts the acquired voice signal into voice data, and outputs the voice data to the CPU 11.

The storage section 16 includes a hard disk drive (HDD), a nonvolatile semiconductor memory, and the like and stores various processing programs and data necessary for executing the programs.

The storage section 16 stores a psychological effect database (DB) 161.

The psychological effect DB 161 stores a correlation model (see FIG. 2) produced based on a correspondence relationship between a degree of a predetermined design element and a degree of an impression evoked in an observer by the design element. Alternatively, the psychological effect DB 161 may store a correlation model produced based on a correspondence relationship between a degree of a predetermined design element and a degree of a physiological phenomenon induced in the observer by the design element.

The degree of the design element includes a layout concentration degree, which is a degree indicating whether constituent elements of an image are concentrated in one region or scattered throughout.

The degree of design elements includes a layout orientation dynamicity, which is a degree to which the constituent elements of the image are aligned at oblique angles other than horizontal or vertical.

The degree of the design element includes the thickness of the maximum character string among the character strings included in the image.

The degree of the design element includes an occupied area ratio of the maximum character string to the total area of the image including the character strings.

The degree of the design element includes an occupied area ratio of a motif having the maximum size other than the characters to the total area of the image. The motif includes, for example, a letter such as an alphabet, a number, and a figure and constitutes a design.

The degree of the design elements includes the linearity or curvature of the contour lines of the constituent elements of the image.

The degree of the design element includes a color difference between a representative color occupying the entire image and each single color. The representative color that occupies the entire image is a color that occupies the largest area after the pixel value of each pixel constituting the image is subjected to color reduction processing. Each single color is orange, yellow, red, black, gray, purple, blue, brown, green, pink, white, or the like.

The degree of the design element includes the number of colors constituting the image.

The degree of the design element includes color contrast within the colors constituting the image.

The degree of the design element may include a quantitative value representing the design element other than those described above.

In the present embodiment, an impression in the degree of the impression stored in the psychological effect DB 161 is expressed by an impression word, which is a word representing the impression. The impression word is an adjective, adjective verb, metaphorical expression, and the like.

The impression word includes a first impression word, a second impression word, and a third impression word. Examples of the first impression word include “powerful”. Examples of the second impression word include “active”. The third impression word represents an impression unique to each design element. Examples of the third impression word include “original”.

Hereinafter, a plurality of impression words is also referred to as second words.

In the psychological effect DB 161, for each of a plurality of design elements, the degree of the meaning of the second word corresponding to the degree of the design element is stored in association with each other.

For each of a plurality of sample images, a plurality of test subjects, who are design experts or ordinary people, evaluates an impression of the sample image to obtain the degree of the impression. The psychological effect DB 161 is produced in advance by associating the degree of the impression with the degree of a design element included in the sample image.

In the evaluation of the impression of the sample image, the test subjects answer, as a percentage, how closely the impression they feel evoked relates to the meanings of the impression words, with respect to the degree of the design element included in the sample image.

FIG. 3 illustrates an example of the sample image. In the example illustrated in FIG. 3, elliptical shapes that are constituent elements of the image are scattered, and the layout concentration degree in the sample image is a value indicating that the elliptical shapes are scattered. The test subject evaluates, for example, that the “powerful” impression is 50%, the “active” impression is 90%, and the “lively” impression is 70%, with respect to the sample image illustrated in FIG. 3.

Next, an operation of the information processing apparatus 10 will be described.

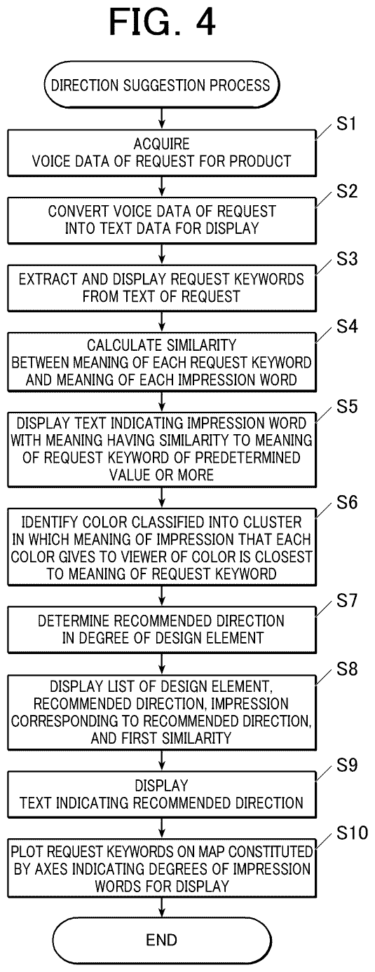

FIG. 4 is a flowchart illustrating a direction suggestion process executed by the information processing apparatus 10. The direction suggestion process is implemented by software processing in cooperation with the CPU of the controller 11 and the program stored in the storage section 16.

By executing the direction suggestion process, the information processing apparatus 10 suggests to a user who is a producer a direction of a design for realizing a request from a client for a product.

### (Direction Suggestion Process)

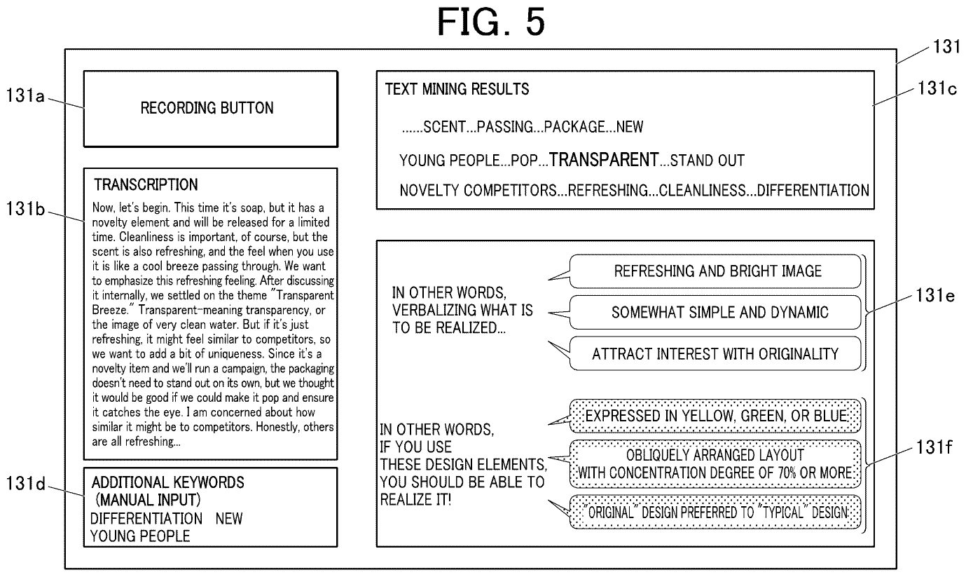

The controller 11 causes the display part 13 to display, for example, a display screen 131 illustrated in FIG. 5. Next, the controller 11 receives a click operation on a recording button 131a provided on the display screen 131. The producer performs a click operation on the recording button 131 via the operation part 12 to hear the request from the client for the product.

Upon receiving the click operation on the recording button 131a, the controller 11 acquires, via the voice input section 15, voice data of the request from the client for the product (step S1).

Next, the controller 11 executes a predetermined voice recognition process on the voice data of the request acquired in step S1 to identify the content of voice, that is, words spoken by a person. Based on the identification result, the controller 11 converts the voice of the voice data into text representing the content of the voice. Next, the controller 11 causes the text representing the content of the voice to be displayed in a transcription region 131b provided in the display screen 131 (step S2). The text representing the content of the voice is text representing the request from the client for the product.

Next, the controller 11 extracts a predetermined number of adjectives and nouns in descending order of appearance frequency from the text representing the request displayed in step S2. The extracted adjectives and nouns are request keywords indicating the request from the client for the product. The controller 11 allows the extracted request keywords to be displayed in a request keyword region 131c provided on the display screen 131 (step S3). In the example illustrated in FIG. 5, the request keywords are, for example, “scent”, “passing”, “package”, “new”, and the like.

The request keywords may be, for example, “proud”, “nostalgic”, “caring”, “headlong”, “family”, and the like.

Hereinafter, the plurality of request keywords is also referred to as first words.

In step S3, the controller 11 functions as an extraction section (extractor) that extracts, from a conversation for determining a design requirement, the first words related to the design requirement. Step S3 is an extraction step.

The controller 11 may receive, from the producer via the operation part 12, an input operation of a word as a request keyword in an additional keyword region 131d provided in the display screen 131.

Next, the controller 11 calculates a similarity between the meaning of each request keyword extracted in step S3 and the meaning of an impression word representing an impression given to a viewer of a design element when the degree of the design element stored in the psychological effect DB 161 is increased. In addition, the controller 11 calculates a similarity between the meaning of each request keyword extracted in step S3 and the meaning of the impression word representing the impression given to the viewer of the design element when the degree of the design element stored in the psychological effect DB 161 is decreased. That is, the controller 11 calculates a first similarity that is a similarity between the meaning of each request keyword and the meaning of each impression word (step S4). Specifically, the controller 11 inputs, into a dictionary-based natural language processing model designed for sentiment analysis, the request keywords extracted in step S3 and the impression word corresponding to the case where the degree of the design element stored in the psychological effect DB 161 is increased. In addition, the controller 11 inputs, into the natural language processing model, the request keywords extracted in step S3 and the impression word corresponding to the case where the degree of the design element stored in the psychological effect DB 161 is decreased. The controller 11 acquires the first similarity as an output of the natural language processing model.

In step S4, the controller 11 calculates the first similarity, which is the similarity between the meaning of the request keyword (first word) and the meaning of the impression word (second word). The controller 11 functions as a first calculation section (first calculator). Step S4 is a first calculation step.

Next, based on the calculation result from step S4, the controller 11 displays text indicating an impression word with a meaning having a similarity to the meaning of the request keyword of a predetermined value (e.g., 50%) or more in a requested image region 131e provided on the display screen 131 (step S5).

Hereinafter, “the degree of an impression word with a meaning having a similarity to the meaning of the request keyword of a predetermined value or more” is also referred to as “the degree of a requested impression word”.

For example, a case where the degree of the requested impression word is “active”, which has a relatively high dynamicity, will be described. In this case, the controller 11 displays “dynamic”, which is text indicating “active”, in the requested image region 131e.

A case where the degree of the requested impression word is “powerful”, which has a relatively high strength, will be described. In this case, the controller 11 displays “assertive”, which is text indicating “powerful”, in the requested image region 131e.

Next, the controller 11 performs the following process regarding the closeness between each single color and the representative color that occupies the entire image as the degree of the design element. Specifically, the controller 11 performs cluster analysis on the degree of each requested impression word and the color difference between the representative color occupying the entire image and each single color. The controller 11 identifies the color of the cluster closest to the degree of each requested impression word based on the result of the analysis (step S6). In other words, the controller 11 identifies a color classified into a cluster in which the meaning of the impression that each color gives to a viewer of the color is closest to the meaning of the request keyword.

Next, the controller 11 determines, based on the first similarity, a recommended direction in the degree of each design element (step S7). The recommended direction in the degree of each design element is a recommended direction in the degree to which the design element is incorporated into the design.

Specifically, the controller 11 sets the threshold value for the first similarity to 50%.

For example, for the design element of “layout orientation dynamicity”, when the first similarity between the meaning of the request keyword and the meaning of the impression word corresponding to the case where the degree of the design element is increased is 50% or more, the controller 11 determines that the recommended direction is “increase”.

For the design element of “layout concentration degree”, when the first similarity between the meaning of the request keyword and the meaning of the impression word corresponding to the case where the degree of the design element is increased is less than 50%, the controller 11 determines that the recommended direction is “decrease”.

For the design element of “number of colors”, when the first similarity between the meaning of the request keyword and the meaning of the impression word corresponding to the case where the degree of the design element is increased is 50% or more, the controller 11 determines that the recommended direction is “increase”.

For the design element of “thickness of the maximum character string”, when the first similarity between the meaning of the request keyword and the meaning of the impression word corresponding to the case where the degree of the design element is increased is 50% or more, the controller 11 determines that the recommended direction is “increase”.

For the design element of “color contrast”, when the first similarity between the meaning of the request keyword and the meaning of the impression word corresponding to the case where the degree of the design element is increased is 50% or more, the controller 11 determines that the recommended direction is “increase”.

For the design element of “linearity”, when the first similarity between the meaning of the request keyword and the meaning of the impression word corresponding to the case where the degree of the design element is increased is 50% or more, the controller 11 determines that the recommended direction is “increase”.

For the design element of “closeness to orange, yellow, or red”, when these colors are determined to belong to a cluster having the highest first similarity compared to other colors, the controller 11 determines that the recommended direction is “bring closer”.

In step S7, the controller 11 determines suggested information regarding the design element(s) for realizing the impression or the physiological phenomenon expressed by the impression word (second word) for which the first similarity is equal to or greater than the predetermined value. The controller 11 functions as a determination section (determiner). Step S7 is a determination step.

The suggested information includes a recommended direction in the degree of each design element.

In step S7, the controller 11 may determine a recommended direction in the degree of each design element based on a statistical value (a mean value, a median value, or the like) of the similarities between the meanings of the respective request keywords and the meanings of the impression words.

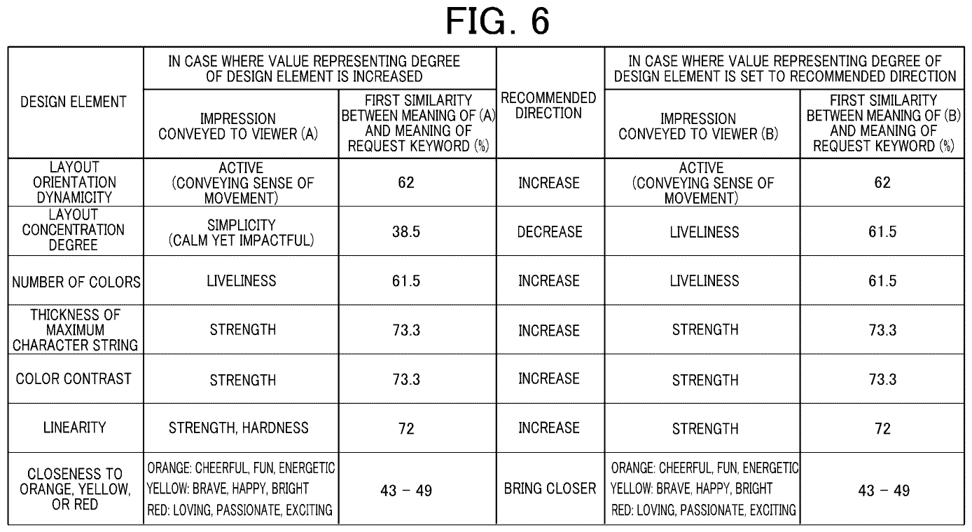

Next, the controller 11 generates a list illustrated in FIG. 6 and displays the list on the display screen 131 (step S8).

The list includes the design element, the recommended direction in the degree of the design element determined in step S7, an impression conveyed to the observer from the design of the recommended direction, and the first similarity.

In the list, the color identified in step S6, that is, the color classified into the cluster in which the meaning of the impression given to the viewer of the color is closest to the meaning of the request keyword is displayed as the design element. In the example illustrated in FIG. 6, the color identified in step S6, that is, the color of the cluster in which the meaning of the impression given to the viewer of the color is closest to the meaning of the request keyword is “orange, yellow, or red”.

For the design elements of “layout orientation dynamicity”, “number of colors”, “thickness of the maximum character string”, “color contrast”, and the “linearity”, the first similarity between the meaning of the request keyword and the meaning of the impression word corresponding to the case where the degree of the design element is increased is 50% or more. Therefore, the recommended direction for those design elements is “increase”. In this case, as the “first similarity between the meaning of the request keyword and the meaning of the impression word corresponding to a case where the degree of the design element is set in the recommended direction” corresponding to the “layout orientation dynamicity”, “number of colors”, “thickness of the maximum character string”, “color contrast”, and “linearity”, the first similarity between the meaning of the request keyword and the meaning of the impression word corresponding to the case where the degree of the design element is increased is displayed.

On the other hand, for the design element of “layout concentration degree”, the first similarity between the meaning of the request keyword and the meaning of the impression word corresponding to the case where the degree of the design element is increased is less than 50%. Therefore, the recommended direction for the design element is “decrease”. In this case, as the “first similarity between the meaning of the request keyword and the meaning of the impression word corresponding to a case where the degree of the design element is set in the recommended direction” corresponding to the “layout concentration degree”, the first similarity between the meaning of the request keyword and the meaning of the impression word corresponding to the case where the degree of the design element is decreased is displayed.

The controller 11 may generate and display a list for each request keyword. Alternatively, the controller 11 may generate and display a list including a statistical value (a mean value, a median value, or the like) of the similarities between the meanings of a plurality of request keywords and the meanings of the impression words.

Next, as illustrated in FIG. 5, the controller 11 displays text indicating the recommended direction in the degree of the design element determined in step S7 in a recommended image region 131f provided in the display screen 131 (step S9).

The controller 11 may receive, from the producer via the operation part 12, a click operation on the text displayed in the recommended image region 131f. In this case, the controller 11 may display reference information corresponding to the clicked text on the display screen 131.

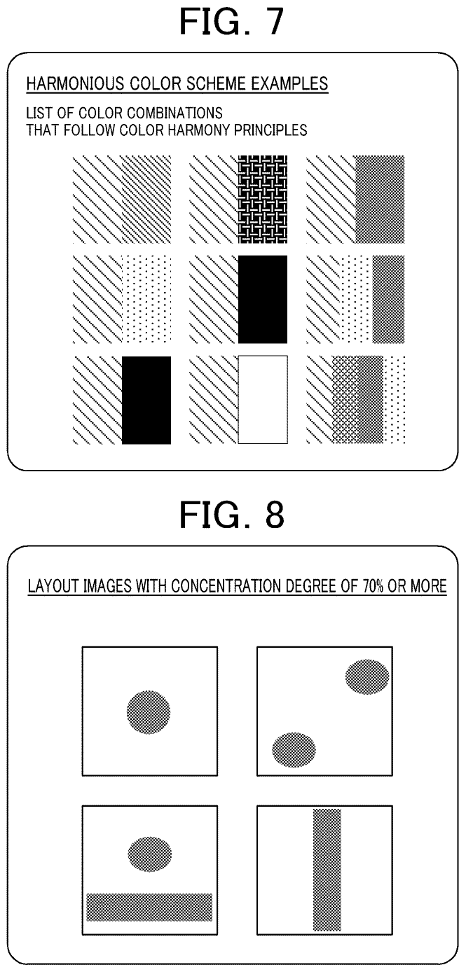

For example, when the text “EXPRESSED IN YELLOW, GREEN, OR BLUE” is clicked, the controller 11 displays an image showing color scheme examples (see FIG. 7) as the reference information.

When the text “OBLIQUELY ARRANGED LAYOUT WITH CONCENTRATION DEGREE OF 70% OR MORE” is clicked, the controller 11 displays layout images (see FIG. 8) as the reference information.

The reference information is an image in which the direction indicating the degree to which the design element is incorporated into the design is expressed.

Next, the controller 11 performs the following process based on the similarity between the meaning of each request keyword and the meaning of each impression word. Specifically, the controller 11 displays each request keyword on the display screen 131 by plotting the request keyword on a map constituted by axes each indicating the degree of the meaning of the impression word (step S10) and ends the direction suggestion process. The axes in the two-dimensional map according to the present embodiment are an axis indicating the degree of “powerful”, which is the first impression word, and an axis indicating the degree of “active”, which is the second impression word.

In steps S8 to S10, the controller 11 displays the suggested information on the display part 13. The controller 11 functions as a display controller. Steps S8 to S10 are display control steps.

The suggested information includes the similarity (first similarity) between the meaning of the request keyword and the meaning of the impression word or a statistical value of the first similarity.

The suggested information includes text indicating a recommended direction in the degree of each design element.

The suggested information includes a map on which each request keyword is plotted. The map is constituted by axes each indicating the degree of the meaning of the impression word.

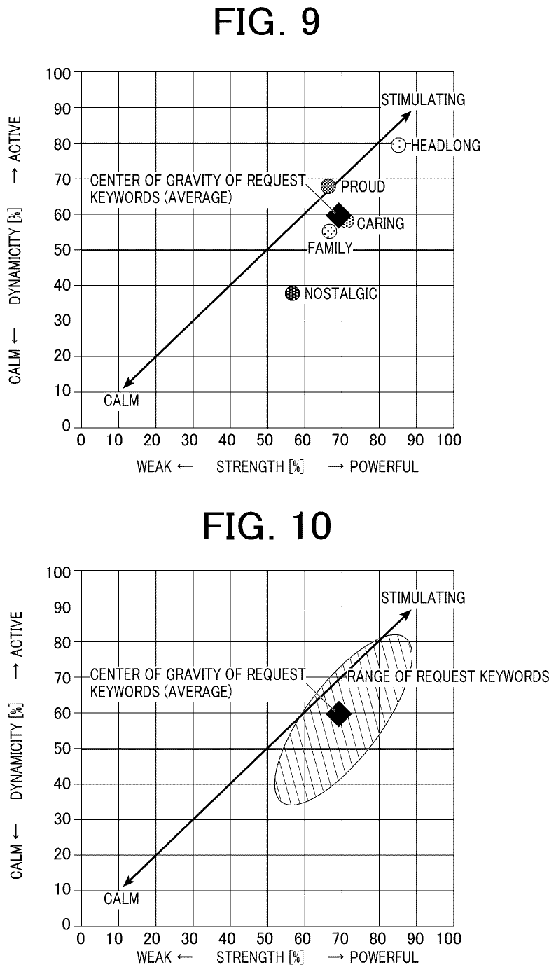

FIG. 9 illustrates an example of the two-dimensional map on which each request keyword is plotted. In the example illustrated in FIG. 9, the request keywords are “proud”, “nostalgic”, “caring”, “headlong”, and “family”. For example, the similarity between the meaning of “proud” and the meaning of “powerful” is equal to or higher than 60% and lower than 70%. The similarity between the meaning of “proud” and the meaning of “active” is equal to or higher than 60% and lower than 70%. The similarity between the meaning of “nostalgic” and the meaning of “powerful” is equal to or higher than 50% and less than 60%. The similarity between the meaning of “nostalgic” and the meaning of “active” is equal to or higher than 30% and less than 40%.

Further, in step S10, the controller 11 plots and displays the center of gravity of the coordinate values of respective request keyword on the map as illustrated in FIG. 9. The center of gravity of the coordinate values of the respective request keywords on the map is an average value in the similarity between the meaning of each request keyword and the meaning of each impression word.

In step S10, the controller 11 may plot and display a statistical value (e.g., a median value) of the coordinate values of the respective request keywords on the map.

In step S10, the controller 11 may display the coordinate values of the respective request keywords on the map in a simplified manner. Specifically, as illustrated in FIG. 10, the controller 11 displays, on the map, a region of a range enclosing the coordinate values of the respective request keywords on the map.

In step S10, the controller 11 may plot and display each request keyword on a one-dimensional axis. Specifically, the one-dimensional axis is an axis indicating the impression words “stimulating” and “calm” (see FIG. 9 and FIG. 10). The impression word “stimulating” is both “powerful”, which has relatively high “strength”, and “active”, which has relatively high “dynamicity”. On the other hand, the impression word “calm” is both “weak”, which has relatively low “strength”, and “calm”, which has relatively low “dynamicity”.

In step S10, the controller 11 may plot and display each request keyword on three-dimensional axes. Specifically, the three-dimensional axes are axes of the first impression word “powerful”, the second impression word “active”, and the third impression word.

After the execution of the direction suggestion process, the producer produces a design image by referring to the text indicating the recommended direction in the degree of each design element, the map on which the request keywords are plotted, and the like displayed on the display screen 131.

After producing the design image, the producer causes the information processing apparatus 10 to determine a matching degree between the produced design image and the request from the client for the product.

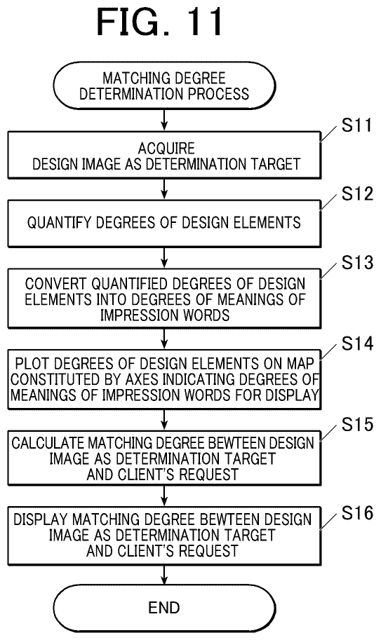

FIG. 11 is a flowchart illustrating a matching degree determination process executed by the information processing apparatus 10. The matching degree determination process is implemented by software processing in cooperation with the CPU of the controller 11 and the program stored in the storage section 16.

By executing the matching degree determination process, the information processing apparatus 10 determines the matching degree between the design image produced by the producer and the request from the client for the product.

### (Matching Degree Determination Process)

The controller 11 acquires, for example, a design image that is a determination target input via the communication section 14 (step S11). Hereinafter, the design image as the determination target is also referred to as an input image.

Next, the controller 11 quantifies degrees of respective design elements constituting the input image acquired in step S11 (step S12).

Next, the controller 11 converts, based on the correlation model stored in the psychological effect DB 161, the degrees of the respective design elements quantified in step S12 into “strength”, which is the degree of the first impression word, and “active”, which is the degree of the second impression word (step S13).

In step S12, the controller 11 quantifies degrees of respective design elements constituting a predetermined design image. In step S13, the controller 11 calculates degrees of meanings of respective impression words (second words) corresponding to the quantified degrees of the respective design elements. The controller 11 functions as a third calculation section (third calculator).

Next, the controller 11 performs the following process based on the degrees of the meanings of the respective impression words converted in step S13. Specifically, the controller 11 plots the degrees of the respective design elements constituting the input image acquired in step S11 on a map having the first impression word “powerful” and the second impression word “active” as axes for display on the display screen 131 (step S14). In other words, the controller 11 performs the following process based on the degrees of the meanings of the respective second words corresponding to the degrees of the respective design elements constituting the predetermined design image. Specifically, the controller 11 displays the degrees of the respective design elements constituting the predetermined design image on a map constituted by axes indicating the degrees of the meanings of the respective second words.

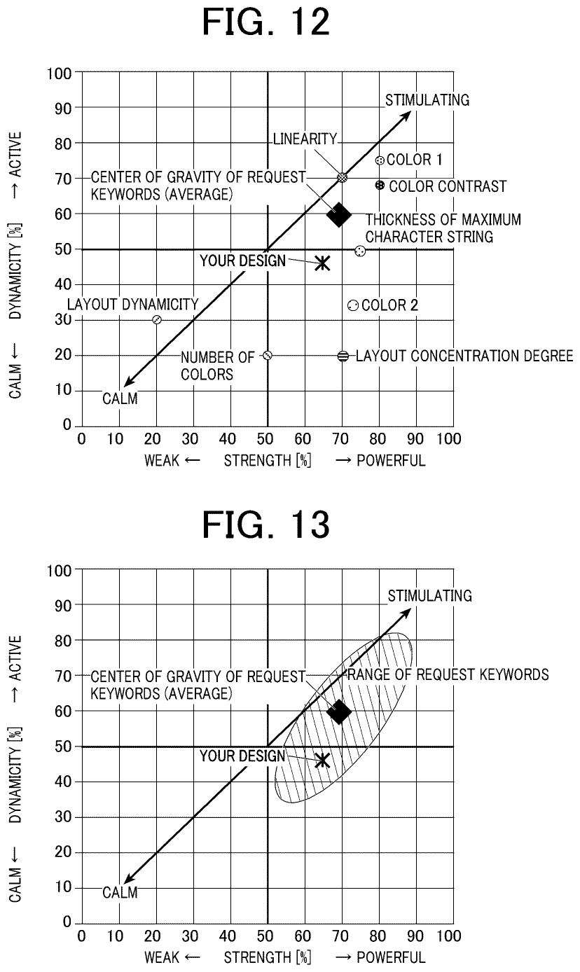

FIG. 12 illustrates an example of the two-dimensional map on which the degrees of the respective design elements constituting the input image are plotted. In the example illustrated in FIG. 12, the degrees of the respective design elements constituting the input image are “layout dynamicity”, “layout concentration degree”, “thickness of the maximum character string”, “linearity”, “color contrast”, “number of colors”, “closeness between the representative color occupying the entire image and color 1”, and “closeness between the representative color occupying the entire image and color 2”.

Further, in step S14, the controller 11 plots and displays the center of gravity of the coordinate values of the degrees of the respective design elements constituting the input image as “your design” on the map as illustrated in FIG. 12.

Furthermore, in step S14, based on the first similarities, the controller 11 displays, on the map, the center of gravity of the coordinate values of the respective request keywords derived in the direction suggestion process.

In step S14, as illustrated in FIG. 13, the controller 11 may display, on the map, a region of a range enclosing the coordinate values of the respective request keywords derived in the direction suggestion process.

In step S14, based on the first similarity, the controller 11 may display, on the map, each request keyword derived in the direction suggestion process.

In step S14, based on the first similarity, the controller 11 may display, on the map, a statistical value (e.g., a median value) based on the coordinate values of the respective request keywords derived in the direction suggestion process.

In step S14, the controller 11 may simplify and display the coordinate values of the degrees of the respective design elements constituting the input image. Specifically, the controller 11 may display, on the map, a region of a range enclosing the coordinate values of the degrees of the respective design elements constituting the input image on the map.

Next, the controller 11 calculates the matching degree between the input image and the request from the client for the product (step S15). Specifically, the controller 11 calculates the matching degree b (%) by the following equation (1), where a is a distance between the center of gravity of the coordinate values of the degrees of the respective design elements constituting the input image and the center of gravity of the coordinate values of the respective request keywords on the map.

$$[ Expression 1 ]$$

$$b = \{ 1 - a / ( 100 \times \sqrt{2} ) \} \times 100 \qquad ( 1 )$$

In step S15, the controller 11 calculates the matching degree between the center of gravity of the coordinate values of the respective request keywords (first words) on the map and the center of gravity of the coordinate values of the degrees of the respective design elements constituting the input image on the map based on the degrees of the meanings of the respective impression words (second words) corresponding to the degrees of the respective design elements constituting the input image. The controller 11 functions as a fourth calculation section (fourth calculator).

In step S15, the controller 11 may calculate the matching degree b (%) based on distances between the coordinate values of the degrees of the respective design elements constituting the input image and the coordinate values of the respective request keywords on the map.

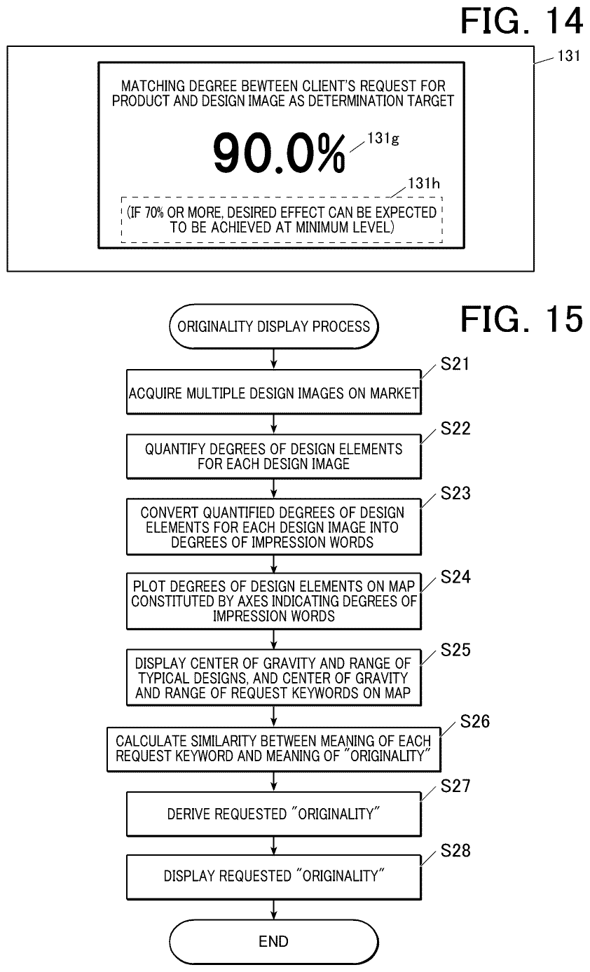

Next, as illustrated in FIG. 14, the controller 11 displays the matching degree 131g calculated in step S15 on the display screen 131 (step S16) and ends the matching degree determination process.

In step S16, the controller 11 displays, on the display screen 131, information 131h that serves as a criterion for determining whether the matching degree is good or bad. The criterion for determining whether the matching degree is good or bad is not limited to the example illustrated in FIG. 14 and may be a value corresponding to the industry, a purpose, or the like for which the design image as the determination target is handled.

After the execution of the matching degree determination process, the producer determines whether the request from the client for the product is realized in the produced design image by referring to the map on which the degrees of the respective design elements constituting the input image displayed on the display screen 131 are plotted, the matching degree between the input image and the request from the client for the product, and the like. When the request from the client for the product is not realized, the producer modifies the produced design image. Next, the producer causes the information processing apparatus 10 to execute the matching degree determination process again for the modified design image.

### Second Embodiment

Next, a second embodiment to which the present disclosure is applied will be described.

An information processing apparatus according to the second embodiment has the same configuration as the information processing apparatus 10 according to the first embodiment. Therefore, FIG. 1 is also used, and illustration and description of the configuration are omitted. Hereinafter, configurations and processes characteristic of the second embodiment will be described.

In step S10 of a direction suggestion process according to the second embodiment, the controller 11 displays, on the map, “originality” in the request from the client for the product.

“Originality” is a third word that has a meaning for which the evaluation changes depending on the experience of the observer.

FIG. 15 is a flowchart illustrating an originality display process executed by the information processing apparatus 10. The originality display process is implemented by software processing in cooperation with the CPU of the controller 11 and the program stored in the storage section 16.

### (Originality Display Process)

The controller 11 acquires, for example, a plurality of design images on the market input via the communication section 14 (step S21).

When the producer is to produce a design image that is a whiskey label, the producer inputs a plurality of design images of major whiskey labels available on the market to the information processing apparatus 10 in step S21.

Next, for each of the plurality of design images acquired in step S21, the controller 11 quantifies the degrees of respective design elements constituting the design image (step S22).

Next, the controller 11 performs the following process based on the correlation model stored in the psychological effect DB 161 for each of the plurality of design images acquired in step S21. Specifically, the controller 11 converts the degrees of the respective design elements quantified in step S22 into “strength”, which is the degree of the first impression word, and “active”, which is the degree of the second impression word (step S23).

Next, the controller 11 performs the following process based on the degrees of the respective impression words converted in step S23. Specifically, the controller 11 plots the degrees of the respective design elements constituting each of the plurality of design images acquired in step S21 on a map having the first impression word “powerful” and the second impression word “active” as axes (step S24).

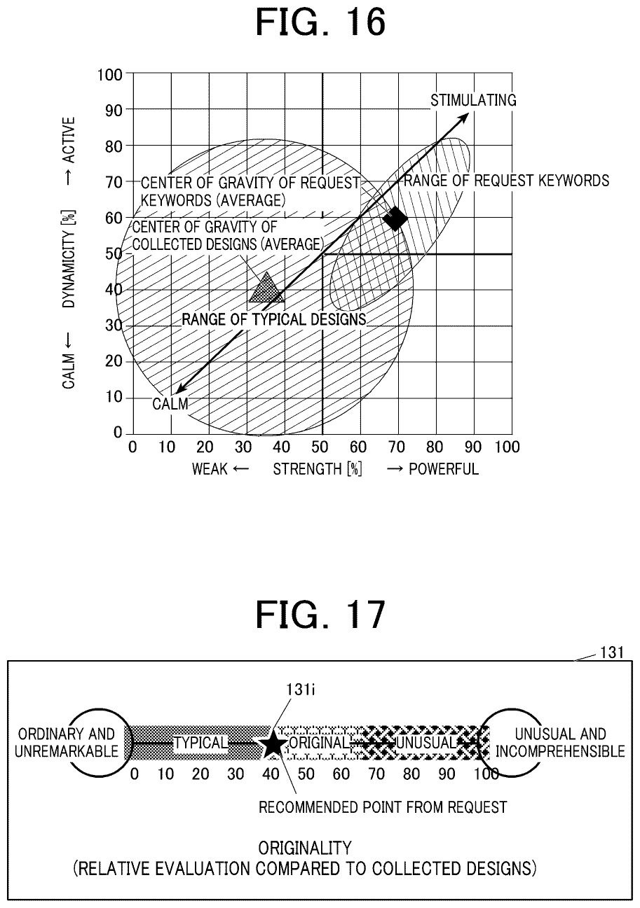

Next, as illustrated in FIG. 16, the controller 11 plots and displays the center of gravity of the coordinate values of the degrees of the respective design elements on the map plotted in step S24 as the “center of gravity of the collected designs” on the map. The “center of gravity of the collective designs” is the center of gravity of typical designs. Furthermore, the controller 11 displays, on the map, a predetermined range from the “center of gravity of the collected designs” on the map as a “range of typical designs” (step S25).

A design that falls within the “range of typical designs” is a “typical” design that resembles a typical example and evokes an impression of “safe,” “common,” or the like in the observer.

A design that falls within a predetermined range in a region beyond the “range of typical designs” is an “original” design that evokes a moderately original impression in the observer and is likely to attract the observer's interest.

A design located in a region beyond a “range of original designs” is an “unusual” design that is too unusual for the observer to recognize or accept.

In step S25, the controller 11 plots and displays, on the map, the center of gravity of the coordinate values of the respective request keywords on the map derived in the direction suggestion process, as illustrated in FIG. 16. Furthermore, the controller 11 displays, on the map, a region of a range enclosing the coordinate values of the respective request keywords on the map.

Next, the controller 11 calculates a second similarity that is a similarity between the meaning of each request keyword acquired in the direction suggestion process and the meaning of “originality” (step S26). Specifically, the controller 11 inputs each request keyword and “unusualness” to the natural language processing model. The controller 11 acquires the second similarity as an output of the natural language processing model.

In this step, when the similarity to the meaning of “unusualness” is 0 to 40%, it is interpreted to mean “being common” and a high similarity to the meaning of “typicalness”. When the similarity to the meaning of “unusualness” is 40 to 65%, it is interpreted to mean “being original and attracting interest” and a high similarity to the meaning of “originality”. When the similarity to the meaning of “unusualness” is 65% or higher, it is interpreted to mean “being too unusual to be recognized or accepted” and a high similarity to the meaning of “unusualness”. Note that the boundary threshold values for each region indicated by the above numerical values are preferably adjusted to optimum values depending on a calculation model used (e.g., image classification model).

In step S26, the controller 11 calculates the second similarity that is a similarity between the meaning of each request keyword (first word) and the meaning of “originality” (third word). The controller 11 functions as a second calculation section (second calculator).

Next, the controller 11 averages the second similarities calculated for the respective request keywords in step S26 and sets the average value of the second similarities as “originality” for realizing the request from the client for the product (step S27). Hereinafter, the “originality” for realizing the request from the client for the product will also be referred to as requested “originality”.

Next, the controller 11 displays the “originality” derived in step S27 and requested by the client on the display screen 131 (step S28) and ends the originality display process.

In step S28, the controller 11 may display the second similarity calculated for each request keyword as the name of the request keyword on the display screen 131.

In step S28, the controller 11 may display, on the display screen 131, a statistical value (e.g., a median value) of the second similarities calculated for the respective request keywords.

FIG. 17 illustrates an example of the display screen 131 on which the requested “originality” is displayed.

In the example illustrated in FIG. 17, the controller 11 plots the requested “originality” as a “recommended point from the request” 131i on an axis indicating the degree of “originality”.

“0” on the “originality” axis is the coordinate value of “the center of gravity of the collected designs”.

In the example illustrated in FIG. 17, a range of “0” to “40” on the “originality” axis is the “range of typical designs”. A design falling within the range of “0” to “40” on the “originality” axis is a “typical” design. A range of “40” to “65” on the “originality” axis is the “range of original designs”. A design falling within the range of “40” to “65” on the “originality” axis is an “original” design. A range of “65” to “100” on the “originality” axis is a “range of unusual designs”. A design located within the range of “65” to “100” on the “originality” axis is an “unusual” design.

Next, a matching degree determination process according to the second embodiment will be described.

In the matching degree determination process according to the second embodiment, the information processing apparatus 10 executes the following process in addition to the matching degree determination process according to the first embodiment.

Specifically, in step S14, the controller 11 further plots and displays, as the “center of gravity of the collected designs” on the map, the center of gravity of the coordinate values of the degrees of the respective design elements on the map derived in the originality display process. The center of gravity of the coordinate values of the degrees of the respective design elements on the map derived in the originality display process is the center of gravity of typical designs. Furthermore, the controller 11 displays the predetermined range from the “center of gravity of the collected designs” as the “range of typical designs” on the map.

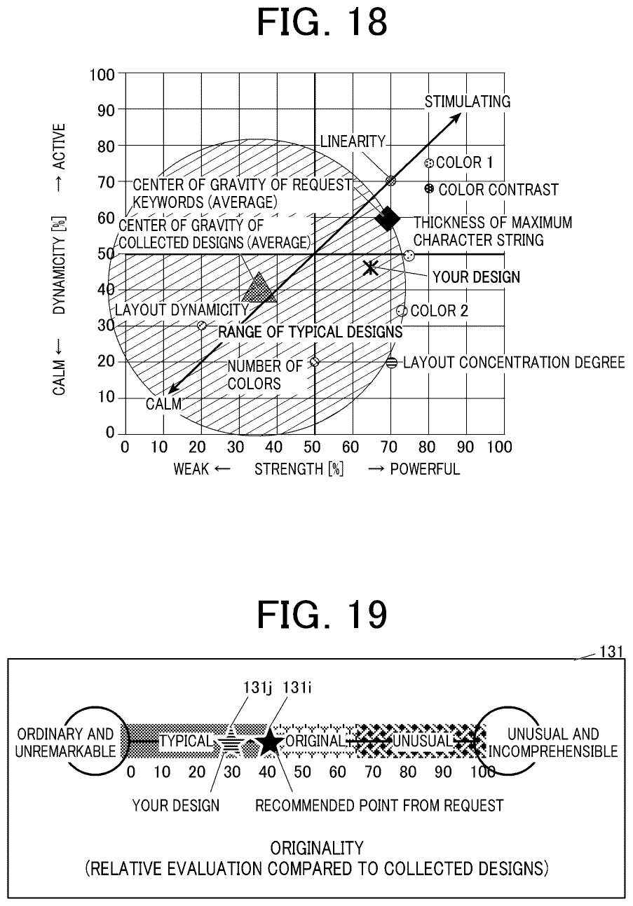

FIG. 18 illustrates an example of the two-dimensional map on which the degrees of the respective design elements constituting the input image and the center of gravity and the range of typical designs are plotted.

Next, the controller 11 calculates “originality” in the input image. Specifically, the controller 11 calculates the “originality” c (%) in the input image by the following equation (2), where d is a distance between “your design” and “the center of gravity of the collected designs”.

$$[ Expression 2 ]$$

$$c = \{ d / ( 100 \times \sqrt{2} ) \} \times 100 \qquad ( 2 )$$

Next, as illustrated in FIG. 19, the controller 11 plots the calculated “originality” 131j in the input image on the “originality” axis for display on the display screen 131. Further, the controller 11 plots the requested “originality” 131i on the “originality” axis.

That is, the controller 11 displays the requested “originality” 131i, which is the second similarity or a statistical value of the second similarity, on the axis indicating the degree of originality. Further, the controller 11 displays the “originality” 131j, which is originality in the degrees of the respective design elements constituting the input image, on the axis indicating the degree of originality.

Hereinafter, the controller 11 executes steps S15 and S16 similar to those in the first embodiment.

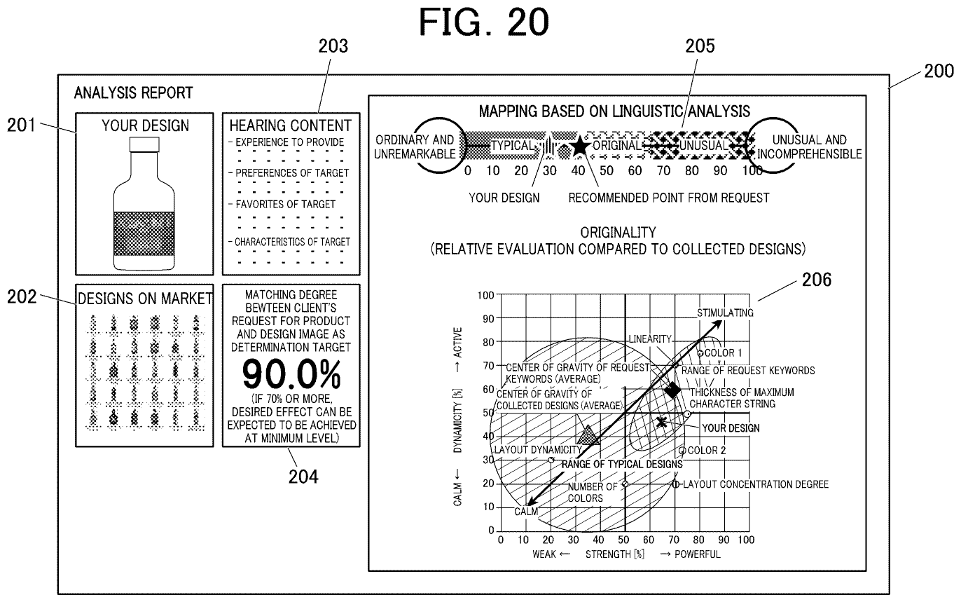

The controller 11 may output a report 200 illustrated in FIG. 20 in the matching degree determination process according to the second embodiment.

In the example illustrated in FIG. 20, the report 200 includes a design image 201 as the determination target. The report 200 includes the plurality of design images 202 on the market acquired in step S21 of the originality display process. The report 200 includes a hearing content 203 at the time of hearing the request from the client for the product in step S1 of the direction suggestion process. The report 200 includes the matching degree 204 between the design image as the determination target and the request from the client for the product, which is calculated in step S15 of the matching degree determination process. The report 200 includes a one-dimensional “originality” map 205. In the one-dimensional map “originality” 205, the requested “originality” and the “originality” in the design image as the determination target are displayed on the “originality” axis. The report 200 includes a two-dimensional map 206. The two-dimensional map 206 is a map having the first impression word “powerful” and the second impression word “active” as axes. On the two-dimensional map 206, the degrees of the respective design elements in the design image as the determination target, their center of gravity, and the center of gravity and the range of typical designs are plotted. Furthermore, the center of gravity of the coordinate values of the respective request keywords and the range of the request keywords are plotted on the two-dimensional map 206.

### Comparison of Examples with Comparative Example

Next, a comparison between design images produced in Example 1 and Example 2 to which the present disclosure is applied and a design image produced in a comparative example that is based on a conventional design image production support method will be described.

The conventional design image production support method will be described.

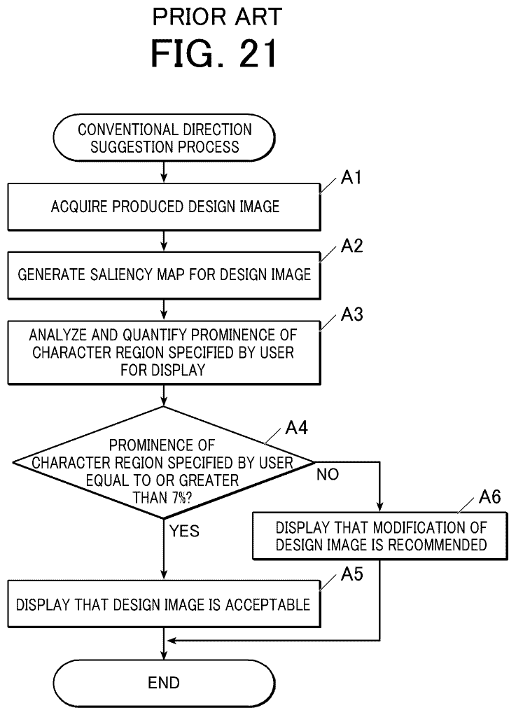

FIG. 21 illustrates a flowchart of a direction suggestion process for suggesting a direction of a design image in the conventional design image production support method.

By executing the conventional direction suggestion process, the information processing apparatus 10 suggests a direction of a design image from the viewpoints of only visual attention, memorability, and readability.

### (Conventional Direction Suggestion Process)

The producer produces a design image. The producer uses a font in the design image that is larger than the “minimum legible character size by age” specified in the JIS standard. The producer uses black backgrounds and white text in the design image to maximize contrast between the text and the background element.

Next, the producer inputs the produced design image to the information processing apparatus 10.

The controller 11 of the information processing apparatus 10 acquires, for example, the design image input via the communication section 14 (step A1).

Next, the controller 11 generates a saliency map for the design image acquired in step A1 (step A2).

Next, the controller 11 receives, from the producer who is a user via the operation part 12, an operation of specifying a character region in the design image acquired in step A1. Next, the controller 11 analyzes and quantifies the prominence of the specified character region based on the saliency map generated in step A2 for display on the display part 13 (step A3).

Next, the controller 11 determines whether the prominence of the character region specified by the user is equal to or greater than a predetermined value (e.g., 7%) (step A4).

When the prominence of the character region specified by the user is equal to or greater than the predetermined value (step A4; YES), this is a case where the character region specified in the design image is “more likely to attract visual attention and be memorable”. In this case, the controller 11 displays on the display part 13 that the produced design image is acceptable (step A5) and ends the conventional direction suggestion process.

On the other hand, when the prominence of the character region specified by the user is less than the predetermined value (step A4; NO), the controller 11 displays on the display part 13 that modification of the design image is recommended (step A6) and ends the conventional direction suggestion process. In this case, the producer modifies the produced design image and causes the information processing apparatus 10 to perform the conventional direction suggestion process again on the modified design image.

Next, evaluation of the design images produced in Example 1 and Example 2 to which the present disclosure is applied and the design image produced in the comparative example by the conventional design image production support method will be described.

In each of Example 1, Example 2, and the comparative example, the produced design image is a label image of a whisky bottle. The size of the bottle and the size of the label are the same in all Example 1, Example 2, and the comparative example. A character string included in the label image is “Memorable Whisky”.

In Example 1, the producer produces a design image as a finished product by referring to text indicating a recommended direction in the degree of each design element, a map on which request keywords are plotted, and the like displayed on the display screen 131 in the direction suggestion process according to the first embodiment.

In Example 2, the producer refers to a one-dimensional map on which the requested “originality” and the “originality” in the design image as the determination target are displayed on the “originality” axis displayed on the display screen 131 in the matching degree determination process according to the second embodiment. In Example 2, it is assumed that the “originality” in the design image as the determination target is insufficient for the requested “originality” as illustrated in FIG. 19.

In this case, the producer refers to a two-dimensional map displayed on the display screen 131 in the matching degree determination process according to the second embodiment. On the two-dimensional map, the degrees of the respective design elements in the design image as the determination target, their center of gravity, the center of gravity and the range of typical designs, and the center of gravity and the range of the request keywords are plotted. The producer modifies the degree of a design element located far from the center of gravity of the request keywords on the two-dimensional map. Further, the producer modifies the design image until the center of gravity of the degrees of the respective design elements in the design image as the determination target exceeds the range of typical designs and falls within the range of the request keywords. The producer uses the modified design image as a finished product.

In the comparative example, the producer uses a design image produced based on the conventional direction suggestion process as a finished product.

Next, an evaluation procedure for the design images will be described.

The finished products of the design images produced in Example 1, Example 2, and the comparative example are presented to the client. Next, comments and evaluation on the finished products of the design images are obtained from the client.

Next, evaluation results of the design images will be described.

The evaluation of the finished product of the design image produced in Example 1 was acceptable, with the comment that “the color image is close to the expected image and is not bad but is insufficient.”

The evaluation of the finished product of the design image produced in Example 2 was better than acceptable, with the comment that “the color image is close to the expected image and has good originality.”

The evaluation of the finished product of the design image produced in the comparative example was unacceptable, with the comment “the color image is different from the expected image, so it's out of the question.”

As described above, in the evaluation of the design images, since the color has a great influence on the overall impression, the color image greatly influences the evaluation results.

In Example 2, since the “originality” requested by the client was higher than the “originality” in the typical examples, the degrees of the design elements different from those of the other design groups commonly seen as the typical examples were applied. This made it possible to produce a design image that conveys “originality”.

### Effects

As described above, a non-transitory computer-readable recording medium according to the present embodiment stores an information processing program that causes the computer (the controller 11) to function as an extraction section that extracts, from a conversation for determining a design requirement, the first word (request keyword) related to the design requirement.

The information processing program causes the computer (controller 11) to function as a first calculation section that calculates the first similarity that is a similarity between the meaning of the first word extracted by the extraction section and the meaning of the second word (impression word) expressing an impression evoked in the observer or a physiological phenomenon induced in the observer by a design element.

The information processing program causes the computer (controller 11) to function as a determination section that determines suggested information on the design element for realizing the impression or the physiological phenomenon expressed by the second word for which the first similarity calculated by the first calculation section is equal to or greater than a predetermined value.

The information processing program causes the computer (controller 11) to function as a display controller that displays the suggested information determined by the determination section on the display part 13.

Therefore, the suggested information displayed on the display part 13 makes it easy to verbalize and share a visual image of a design image. Even when the design requirement is expressed using the same word, but different visual design elements are envisioned by different people, any word can be converted into visual information represented by the design element(s) through the meaning of that word and shared. This makes it easier to share a visual image of the design to be finally realized.

This allows for easy sharing of an image in a design image when sharing the client's request between the client and the producer, thereby supporting efficient production of a design image.

In the information processing program according to the present embodiment, the determination section (controller 11) determines the suggested information based on a database in which, for each of a plurality of design elements, the degree of the meaning of the second word (impression word) is associated with the degree of the corresponding design element.

This allows the suggested information to be determined with high accuracy.

In the information processing program according to the present embodiment, based on the first similarities or a statistical value of the first similarities, the determination section (controller 11) determines, for each design element, a direction indicating a degree to which the design element is incorporated into the design as the suggested information.

The suggested information includes the first similarity for each first word or the statistical value of the first similarities.

This makes it possible to quantitatively display an image, a physiological response, and the like, that a person instinctively brings to mind, thereby allowing for easy sharing of an image in a design image.

In the information processing program according to the present embodiment, the display controller (controller 11) displays an image in which the direction indicating the degree to which the design element is incorporated into the design is expressed.

This allows for easy sharing of a visual image of a design image that realizes the design requirement.

In the information processing program according to the present embodiment, based on the first similarities, the display controller (controller 11) displays, on the map constituted by axes indicating the degrees of meanings of the second words (impression words), at least one of the first words, the center of gravity of the coordinate values of the first words on the map, or a statistical value based on the coordinate values.

This makes it possible to visually grasp a direction of an impression corresponding to the design image that realizes the design requirement.

The information processing program according to the present embodiment causes the computer (controller 11) to function as a second calculation section that calculates the second similarity that is a similarity between the meaning of the first word and the meaning of the third word (originality). The third word is a word having a meaning for which evaluation changes depending on the experience of the observer.

This makes it possible to attain originality in the design image that realizes the design requirement.

In the information processing program according to the present embodiment, the display controller (controller 11) displays the second similarity or a statistical value of the second similarity on an axis indicating the degree of originality.

This makes it possible to visually grasp the originality in the design image that realizes the design requirement.

In design production, there are times when deliberately “unusual and hard-to-understand” designs are required, as in the case for novelty goods. In this case as well, the originality in the design image that realizes the design requirement can be referred to.

The information processing program according to the present embodiment causes the computer (controller 11) to function as a third calculation section that quantifies the degrees of respective design elements constituting a predetermined design image and calculates the degrees of the meanings of respective second words (impression words) corresponding to the quantified degrees of the respective design elements.

The display controller (controller 11) displays, based on the degrees of the meanings of the respective second words corresponding to the degrees of the respective design elements constituting the predetermined design image, the degrees of the respective design elements constituting the predetermined design image together with the suggested information on the map constituted by the axes indicating the degrees of the meanings of the respective second words.

Therefore, after a design image has been produced, it is possible to quantitatively confirm whether the intended impression is realized in the produced design image. This makes it possible to efficiently produce a design image more suitable for the purpose.

In the information processing program according to the present embodiment, based on the first similarities, the display controller (controller 11) displays, on the map as the suggested information, at least one of the first words (request keywords), the center of gravity of the coordinate values of the first words on the map, or a statistical value based on the coordinate values.

This makes it possible to quantitatively confirm whether the design requirement is realized in the produced design image.

The information processing program according to the present embodiment causes the computer (controller 11) to function as the second calculation section that calculates the second similarity that is a similarity between the meaning of the first word (request keyword) and the meaning of the third word (“originality”). The third word is a word having a meaning for which evaluation changes depending on the experience of the observer.

The display controller (controller 11) displays the second similarity or a statistical value of the second similarity, and originality in the degrees of the respective design elements constituting the predetermined design image on an axis indicating the degree of originality.

This makes it possible to quantitatively confirm whether the produced design image realizes the “originality” requested by the client for the product.

The information processing program according to the present embodiment causes the computer (controller 11) to function as a fourth calculation section that calculates the matching degree between: the coordinate values of the first words (request keywords) or the center of gravity of the coordinate values of the first words on the map; and the coordinate values of the degrees of the respective design elements constituting the predetermined design image or the center of gravity of the coordinate values of the degrees of the respective design elements based on the degrees of the meanings of the respective second words (impression words) corresponding to the degrees of the respective design elements constituting the predetermined design image.

The display controller (controller 11) displays the matching degree on the display part 13.

This makes it possible to quantitatively confirm whether the request from the client for the product is realized in the produced design image.

The descriptions in the above-described embodiments are examples of the non-transitory computer-readable recording medium storing the information processing program, the information processing apparatus, and the information processing method according to the present disclosure, and the present disclosure is not limited thereto. The detailed configuration and detailed operation of each component constituting the apparatus can also be appropriately changed without departing from the spirit of the present disclosure.

For example, characteristic processes in the respective embodiment may be combined.

The program for executing each process may be stored in a portable recording medium. Further, a carrier wave may be applied as a medium for providing program data via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. A non-transitory computer-readable recording medium storing a computer-executable information processing program, the program causing a computer to function as:
an extractor that extracts, from a conversation for determining a requirement of a design, a first word related to the requirement of the design;
a first calculator that calculates a first similarity that is a similarity between a meaning of the first word extracted by the extractor and a meaning of a second word that expresses an impression evoked or a physiological phenomenon induced in an observer by a design element;
a determiner that determines suggested information on the design element for realizing the impression or the physiological phenomenon expressed by the second word for which the first similarity calculated by the first calculator is equal to or greater than a predetermined value; and
a display controller that displays the suggested information determined by the determiner on a display.

2. The recording medium according to claim 1, wherein
the design element includes a plurality of design elements, and
the determiner determines, for each of the plurality of design elements, the suggested information based on a database in which a degree of the meaning of the second word is associated with a degree of the each of the plurality of design elements.

3. The recording medium according to claim 1, wherein,
based on the first similarity or a statistical value of the first similarity, the determiner determines, as the suggested information for each of the design element, a direction indicating a degree to which the each of the design element is incorporated into the design, and
the suggested information includes the first similarity for each of the first word or the statistical value of the first similarity.

4. The recording medium according to claim 3, wherein the display controller displays an image in which the direction indicating the degree to which the each of the design element is incorporated in the design is expressed.

5. The recording medium according to claim 1, wherein, based on the first similarity, the display controller displays, on a map constituted by an axis indicating a degree of the meaning of the second word, at least one of the first word, a center of gravity of a coordinate value of the first word on the map, or a statistical value based on the coordinate value.

6. The recording medium according to claim 1, wherein
the program causes the computer to function as a second calculator that calculates a second similarity,
the second similarity is a similarity between the meaning of the first word and a meaning of a third word, and
the third word is a word having the meaning for which an evaluation changes depending on an experience of the observer.

7. The recording medium according to claim 6, wherein the display controller displays the second similarity or a statistical value of the second similarity on an axis indicating a degree of originality.

8. The recording medium according to claim 1, wherein
the program causes the computer to function as a third calculator that:
quantifies a degree of each of a design element constituting a predetermined design image; and
calculates a degree of the meaning of the second word corresponding to the quantified degree of the each of the design element, and,
based on the degree of the meaning of the second word, the display controller displays, on a map constituted by an axis indicating the degree of the meaning of the second word, the degree of the each of the design element constituting the predetermined design image together with the suggested information.

9. The recording medium according to claim 8, wherein, based on the first similarity, the display controller displays, on the map as the suggested information, at least one of the first word, a center of gravity of a coordinate value of the first word on the map, or a statistical value based on the coordinate value.

10. The recording medium according to claim 8, wherein
the program causes the computer to function as a second calculator that calculates a second similarity,
the second similarity is a similarity between the meaning of the first word and a meaning of a third word,
the third word is a word having the meaning for which an evaluation changes depending on an experience of the observer, and
the display controller displays the second similarity or a statistical value of the second similarity, and originality in the degree of the each of the design element constituting the predetermined design image on an axis indicating a degree of the originality.

11. The recording medium according to claim 9, wherein
the program causes the computer to function as a fourth calculator that calculates a matching degree between:
the coordinate value of the first word or the center of gravity of the coordinate value of the first word on the map; and
a coordinate value of the degree of the each of the design element constituting the predetermined design image or a center of gravity of a coordinate value of the degree of the each of the design element on the map based on the degree of the meaning of the second word, and
the display controller displays the matching degree on the display.

12. An information processing apparatus comprising a hardware processor that:
extracts, from a conversation for determining a requirement of a design, a first word related to the requirement of the design;
calculates a first similarity that is a similarity between a meaning of the extracted first word and a meaning of a second word that expresses an impression evoked or a physiological phenomenon induced in an observer by a design element;
determines suggested information on the design element for realizing the impression or the physiological phenomenon expressed by the second word for which the calculated first similarity is equal to or greater than a predetermined value; and
displays the determined suggested information on a display.

13. An information processing method comprising:
extracting, from a conversation for determining a requirement of a design, a first word related to the requirement of the design;
calculating a first similarity that is a similarity between a meaning of the first word extracted in the extracting and a meaning of a second word that expresses an impression evoked or a physiological phenomenon induced in an observer by a design element;
determining suggested information on the design element for realizing the impression or the physiological phenomenon expressed by the second word for which the first similarity calculated in the calculating is equal to or greater than a predetermined value; and
displaying the suggested information determined in the determining on a display.
